(19) United States
(12) Patent Application Publication
(10) Pub. No.: US 2020/0356940 A1
(43) Pub. Date: Nov. 12, 2020

(54) System and Method to Determine Facility Routing at Quote Level and to Provide Disruptive Demand Signal

(71) Applicant: DELL PRODUCTS, LP, Round Rock, TX (US)

(72) Inventors: Shibi Panikkar, Bangalore (IN); Rohit Gosain, Bangalore (IN)

(21) Appl. No.: 16/407,049

(22) Filed: May 8, 2019

(51) Int. Cl. G06Q 10/06; G06N 5/02

(52) U.S. Cl. CPC G06Q 10/063116; G06N 5/02

(57) ABSTRACT

A system may determine, based on details for an order and based on a facility prediction model, a first facility to fulfill the order. The system may determine whether one or more outlier facilities exist for the order. In response to no outlier facilities existing, the system may assign the first facility as an assigned facility for the order. Otherwise, the system may determine, based on a set of routing rules, whether to re-route the order to a second one of the outlier facilities, and assign, based on the re-routing determination, either the first facility or the second facility as the assigned facility for the order. The system may confirm the order based on the first facility or second being the assigned facility.

### FIELD OF THE DISCLOSURE

The present disclosure generally relates to information handling systems, and more particularly relates to a determining facility routing at quote level and providing a disruptive demand signal to the determined facility.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A system receives details for an order, which order includes multiple information handling systems. Based on the details for the order and based on a facility prediction model, the system determines a first facility to fulfill the order, and determines whether one or more outlier facilities exist for the order. In response to a determination that no outlier facilities exist, the system assigns the first facility as an assigned facility for the order, and confirms the order at a quote level based on the first facility being the assigned facility. However, in response to a determination that one or more outlier facilities exist and based on a set of routing rules, the system determines whether to re-route the order to a second facility of the one or more outlier facilities. Based on the re-routing determination, the system assigns either the first facility or the second facility as the assigned facility for the order, and confirms the order based on the first facility or second being the assigned facility. In response to a facility being determined, the system checks the current forecasting of the order including a normal and a large order, to determine if the current order may disrupt a forecasting and plan of purchase for the forecasted orders of the determined facility. If so, the system marks the order as a disrupted order ands send a disruptive signal to the facility.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a portion of an information handling system according to at least one embodiment of the disclosure;

FIG. 2 is a block diagram of another information handling system according to at least one embodiment of the disclosure;

FIG. 3 is a block diagram of a facility prediction model according to at least one embodiment of the disclosure;

FIG. 4 is a block diagram of a disruptive prediction model according to at least one embodiment of the disclosure;

FIG. 5 is a flow diagram of a method for deriving a manufacturing facility for an order according to at least one embodiment of the present disclosure;

FIG. 6 is a flow diagram of a method for determining whether an order may be disruptive to an assigned facility according to at least one embodiment of the present disclosure;

FIG. 7 is a flow diagram of another method for deriving a manufacturing facility for an order according to at least one embodiment of the present disclosure; and

FIG. 8 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

A system receives details for an order, which order includes multiple information handling systems. Based on the details for the order and based on a facility prediction model, the system determines a first facility to fulfill the order. The system determines whether one or more outlier facilities exist for the order. In response to a determination that no outlier facilities exist, the system assigns the first facility as an assigned facility for the order, and confirms the order based on the first facility being the assigned facility. However, in response to a determination that one or more outlier facilities exist and based on a set of routing rules, the system determines whether to re-route the order to a second facility of the one or more outlier facilities. Based on the re-routing determination, the system assigns either the first facility or the second facility as the assigned facility for the order, and confirms the order based on the first facility or second being the assigned facility.

These systems and methods to determine facility routing and provide a disruptive demand signal at quote level provide various advantages and benefits over other previous systems that select and assign a facility to manufacture one or more information handling systems of an order without knowledge of an impact the order may have on the facility. In particular, during a quote level of the order process, the system may execute a facility prediction model to determine a manufacturing facility to assign the order and provide a confirmation of the assigned facility. In an example, the facility prediction model may utilize a historical data and parameters associated with the order to determine a facility to assign the order. Upon assigning a facility, the system may determine whether the order will be disruptive to the assigned facility during a period of time when the order is predicted to be downloaded and fulfilled at the assigned facility. If so, the system may provide a disruptive signal to the assigned facility, and the disruptive signal may indicate a need for preparations at the assigned facility to accommodate the order during the period of time when the order is predicted to be downloaded and fulfilled. These operations improve the order taking procedure to correctly identify the facility to fulfill the order. Additionally, the determination of whether the order may disrupt the facility may provide an improvement by ensuring that the order is fulfilled on time and reducing an amount of raw materials that may need to always be kept at the facility and thereby lowering facility cost.

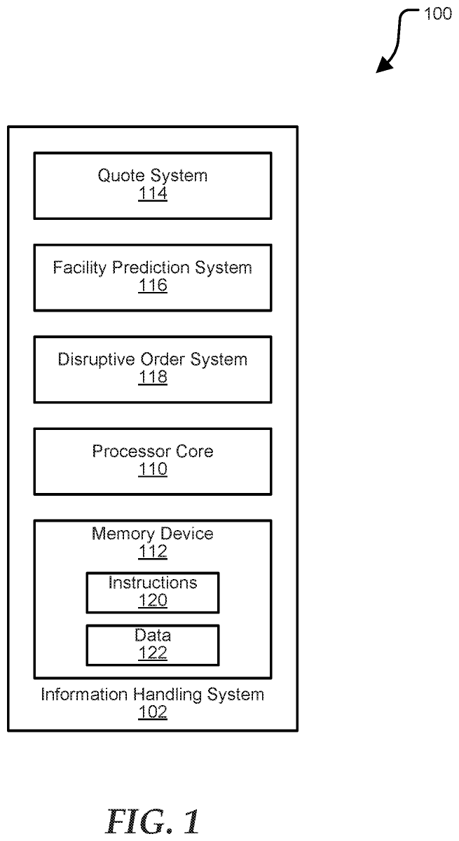

FIG. 1 shows a portion of an information handling system 100. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various other I/O devices, such as a keyboard, a mouse, and a video display. The information handling system may also include one or more busses operable to transmit communications between the various hardware components.

The information handling system 100 includes a processor core 110, a memory device 112, a quote system 114, a facility prediction system 116, and a disruptive order system 118. In an embodiment, information handling system 100 may include additional or fewer components, not shown in or discussed with reference to FIG. 1, without varying from the scope of this disclosure. In an embodiment, quote system 114, facility prediction system 116, and disruptive order system 118 may be located within a single information handling system, such as information handling system 100, or may be distributed across multiple information handling systems without varying from the scope of the disclosure. In an example, memory device 112 may store a set of instructions 120 to be executed by processor core 110. Memory device 112 may also store data 122 that may be provided by and/or utilized by one or more or processor core 110, quote system 114, facility prediction system 116, and disruptive order system 118. In an example, execution of instructions 120 may cause processor 110 to implement quote system 114, facility prediction system 116, and disruptive order system 118.

In certain examples, quote system 114 may perform one or more operations associated with an order for one or more information handling system. For example, quote system 114 may receive an order and generate a quote based on the received order. In an example, quote system 114 may receive details associated with the order from any suitable source. In an embodiment, possible sources may include, but are not limited to, an individual associated with an information handling system manufacturing, such as a sales representative, and a website graphical user interface.

In an example, facility prediction system 116 may perform one or more operations to determine and assign a facility to an order. For example, facility prediction system 116 may execute a computer prediction model to determine a first facility to assign to the order. In certain examples, parameters for the order may be provided as input to the computer prediction model, which in turn may provide an output, such as an assigned facility to fulfill the order. In an embodiment, the parameters may include, but are not limited to, a quote type, fulfillment changes in a region associated with the order, a customer name, shipping patterns, whether the order is for a new produce, a season associated with the order, and a month associated with the order.

In an example, facility prediction system 116 may also perform one or more post processing operations to determine whether one or more outlier facilities exist for the order. In an embodiment, an outlier facility may be any facility that one or more similar orders have recently been diverted to and fulfilled at this facility instead of the assigned facility. Based on one or more outlier facilities existing, facility prediction system 116 may utilize predetermined rules to determine whether to keep the order assigned to the first facility or to re-assign or re-route the order to one of the outlier facilities.

In an example, disruptive order system 118 may perform one or more operations to determine whether an order assigned to a facility will be disruptive to a capacity of the assigned facility to fulfill the order. For example, disruptive order system 118 may execute a disruptive order model to determine whether the order will be disruptive. In an embodiment, historical data for the assigned facility and details for the order may be provided as input to the disruptive order model, and an output of the model may indicate whether the order will be disruptive to the assigned facility. In an example, the details for the order may include, but is not limited to, a proposed order download week, a number of parts needed for the order, and a completion date for the order. In an example, the historical data may include, but is not limited to, average order sizes for proposed order download week, daily parts inventory maintained at the assigned facility for the proposed order download week, the capacity planning for the assigned facility for the proposed order download week, and holidays that may affect the assigned facility.

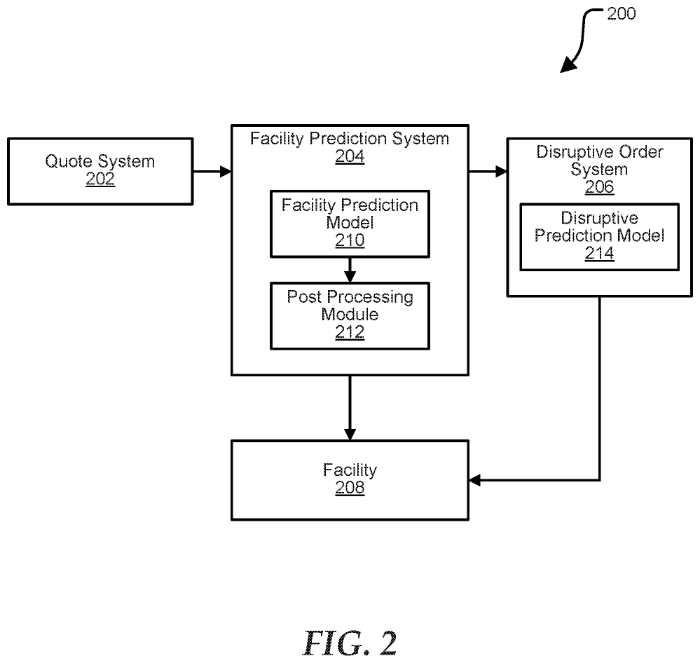

FIG. 2 shows a block diagram of a system 200 according to at least one embodiment of the disclosure. System 200 includes a quote system 202, a facility prediction system 204, a disruptive order system 206, and a facility 208. In an embodiment, information handling system 200 may include additional or fewer components, not shown in or discussed with reference to FIG. 2, without varying from the scope of this disclosure. For example, system 200 may include more that addition facilities. However, for clarity only a single facility 208, representing an assigned facility, is shown if FIG. 2. In an embodiment, quote system 202 may be any suitable device and may be substantially the same as quote system 114 of FIG. 1. Similarly, facility prediction system 204 may be any suitable device and may be substantially the same as facility prediction system 116 of FIG. 1, and disruptive order system 206 may be any suitable device and may be substantially the same as disruptive order system 118 of FIG. 1.

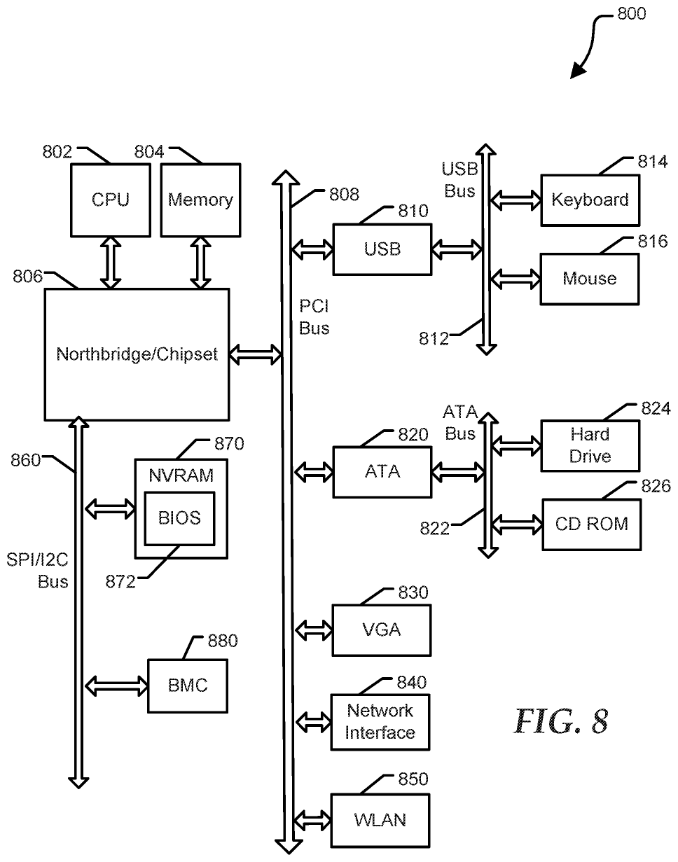

During operation of system 200, quote system 202 may receive details associated with an order for one or more information handling systems, such as information handling system 800 of FIG. 8. Based on the details of the order, quote system 202 performs one or more operations to complete a quote for the order. For example, quote system 202 may determine different parameters for the quote including, but not limited to, a quote type, such as a laptop, server, or the like, a time period when the order may be completed, a delivery date for the order, a season associated with the delivery date, the month associated with the delivery date, a geographical region associated with delivery location, a customer name, and a price. In response to determining the parameters for the quote, quote system 202 may provide a confirmation of the quote to the customer. In an example, the confirmation of the quote may indicate the delivery date for the order to the user.

In previous systems, a manufacturing facility to fulfill the order may not be selected much less notified of the order until a time period that the facility needs to build the one or more information handling systems and complete the order. However, the size of the order may be larger than the facility is capable of handling at the time period that the order is to be fulfilled. In these previous facilities, when a large order, such as an order for 7000 information handling systems, is place an assigned facility is not notified about the order until manufacturing time, such that the facility either had to maintain a large over stock of parts to handle large orders or the large orders may not be completed in time. In an example, a large over stock of parts may be any suitable amount, such as thirty percent, thirty-five percent, or forty percent, above an average amount of parts used in the facility. This large over stock of parts may greatly increase costs at a facility. However, system 200 disclosed herein may provide may benefits over previous systems including, but not limited to, cost savings at manufacturing facilities and timeliness of order completion.

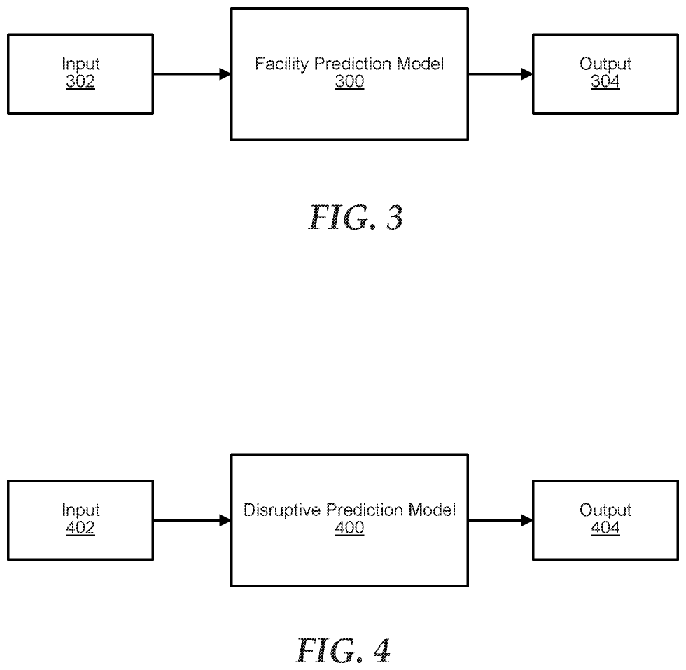

In certain examples, during the quote level or stage of the order process, quote system 202 may provide, in any suitable manner, the details and parameters associated with an order to facility prediction system 204. In response to receiving the details and parameters, facility prediction system 204 may execute facility prediction model 210 to determine and assign a facility to fulfill the order. The facility prediction model 210 may be any suitable type computer model, including but not limited to, a linear regression model and a clustering prediction model. Execution of facility prediction model will be described with respect to FIG. 3.

FIG. 3 illustrates a facility prediction model 300 according to at least one embodiment of the disclosure. In an example, facility prediction model 300 may be substantially similar to facility prediction model 210. Facility prediction model 300 includes an input layer to receive input 302, one or more hidden layers to perform one or more operations on input 302, and an output layer to provide output 304. In an embodiment, input 302 may include the details and parameters for the order received from quote system 202, and historical data of order assignments to the different facilities.

Based on performing operations at one or more hidden layers, facility prediction model 300 may provide output 304 including an identification of a facility to assign the order. In an embodiment, the identified facility for the order may be a facility that has fulfilled a largest number of orders with similar details and parameters as the current order. Facility prediction model 300 may also include the identity one or more outlier facilities within output 304. In an example, an outlier facility may be any facility, other facility originally identified as the assigned facility for the order, that similar orders have recently been diverted to during manufacturing stage of information handling systems within an order. For example, output 304 may indicate that 2000 instances of similar orders have been assigned to and fulfilled by a first facility, 35 instances have been assigned to and fulfilled by a second facility, 20 instances have been assigned to and fulfilled by a third facility, 10 instances have been assigned to and fulfilled by a fourth facility, and 1 instance has been assigned to and fulfilled by a second facility. In this example, the first facility may be assigned as the facility for the order and the second, third, and fourth facilities may be identified as outlier facilities.

Referring back to FIG. 2, output 304 may be provided to a post processing module 212, which in turn may perform one or more operations to determine whether the order should stay assigned to the original assigned facility, such as the first facility, or be re-routed to one of the outlier facilities. For example, post processing module 212 may execute a configurator with one or more rules to determine whether the order should be assigned to one of the outlier facilities. Post processing module 212 may determine whether one of the outlier facilities is a second touch facility, and if so, this facility will be removed as a possible assigned facility for the order. In an embodiment, a second touch facility may be any facility that an order is shipped after most of the order has been completed. For example, if an order is for a desktop computer with a mouse and keyboard, the assigned facility may manufacture the desktop computer, which may then be sent to a second touch facility to add the keyboard and mouse to the desktop computer to complete the order. Thus, post processing module 212 may determine that an order is not to be re-routed or re-assigned to any outlier facility that is a second touch facility because only a small portion of the order is completed at the second touch facility after another facility has already fulfilled most of the order.

Based on the second touch facility, if one exists, being removed from the re-routing options, post processing module 212 may determine whether a configurator rule indicate that similar type of orders no longer are sent to a particular outlier facility. If so, post processing module 212 may remove that particular outlier facility as a possibility for the order. Post processing module 212 may determine whether a number of recent orders have been sent to an outlier facility that has not be eliminated as a possibility based on any suitable rule including, but not limited to, the rules described above. Based on this determination, post processing module 212 may either identify that the order should continue to be assigned to the first facility or identify that the order should be re-assigned to one of the outlier facilities.

Based on this identification, facility prediction system 204 may assign the order to a facility, such as facility 208. In an example, facility prediction system 204 may notify facility 208 that an order has been assigned to facility 208, and also provide details about the order to facility 208. Facility prediction system 204 may provide the identification of the assigned facility 208 and the details and parameters to the disruptive order system 206.

In an example, disruptive order system 206 may perform one or more operations to determine whether the order will be disruptive to the assigned facility 208. For example, disruptive order system 206 may execute a computer model, such as disruptive prediction model 214, to determine whether the order will be disruptive to the assigned facility 208. The disruptive prediction model 214 may be any suitable type computer model. Execution of a disruptive prediction model will be described with respect to FIG. 4.

FIG. 4 shows a block diagram of a disruptive prediction model 400 according to at least one embodiment of the disclosure. In an example, disruptive prediction model 400 may be substantially similar to disruptive prediction model 214. Disruptive prediction model 400 includes an input layer to receive input 402, one or more hidden layers to perform one or more operations on input 402, and an output layer to provide output 404. In an embodiment, input 402 may include any suitable data including, but not limited to, the details and parameters for the order and historical data of assigned facility 208.

In an example, disruptive prediction model 400 may determine whether the order will be disruptive based on the following data: the size of the order; a week that the order will be downloaded by the assigned facility to fulfill the order; a sales history for that week in the assigned facility; a daily sale inventory maintained at the assigned facility for that week; capacity planning for the facility; whether a holiday may affect operational hours of the facility during that week; or the like. Based on performing operations at one or more hidden layers, disruptive prediction model 400 may provide output 404 indicating whether the order will be disruptive to the assigned facility, such as facility 208. In an example, if disruptive prediction model 400 determines that the assigned facility 208 has not fulfilled an order equal to or greater than the current order during the week the order will be in facility 208 and that the daily sales inventory for the factory is not sufficient for the size of the order, disruptive prediction model 400 may determine that the order will be disruptive to facility 208.

Based on a determination that the order will be disruptive to facility 208, disruptive order system 206 and facility 208 may perform one or more operations to prevent the disruption from occurring. For example, disruptive order system 206 may provide a disruptive demand signal to facility 208. In an embodiment, the disruptive demand signal may notify facility 208 of the details of the order including, but not limited to, the size of the order, the parts needed for the order, and the time period that the order should be completed. In response to the disruptive demand signal, steps may be taken at facility 208 to increase the daily sales inventory at facility 208 to a level needed for the week or time period that the order is to be fulfill. Thus, system 200 may provide advantages and benefits of ensuring that an assigned facility will have the necessary daily sales inventory to fulfill a disruptive order on time without having to always keep the daily sales inventory at a threshold amount above historical use. Therefore, system 200 may decrease expenses at facility 208 while enabling any assigned order to be fulfilled on time, even if that order may be disruptive to facility 208.

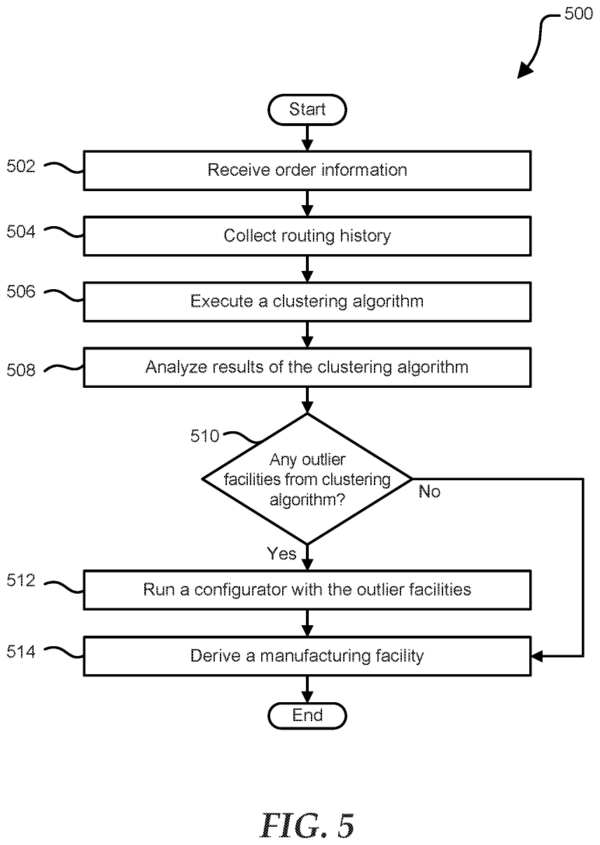

FIG. 5 is a flow diagram of a method 500 for deriving a manufacturing facility for an order according to at least one embodiment of the present disclosure. It will be readily appreciated that not every method step set forth in this flow diagram is always necessary, and that certain steps of the methods can be combined, performed simultaneously, in a different order, or perhaps omitted, without varying from the scope of the disclosure.

At block 502, information for an order is received. Block 502 may be performed in a manner described above. In an example, the information or parameters may include a type of order, such as desktop computer, server, or the like, the size of the order, a time period the order is to be completed, or the like. In an embodiment, the information may be utilized to generate a quote and confirmation of the order.

At block 504, routing history is collected. Block 504 may be performed in a manner described above. In an example, the routing history may include information identifying one or more facilities that similar orders have been routed, the time period when each facility was utilized to fulfill this type of order, or the like.

At block 506, a clustering algorithm is executed. Block 506 may be performed in a manner described above. In an embodiment, the clustering algorithm may be executed within a facility prediction model to identify one or more facilities that may be assigned the order.

At block 508, results of the clustering algorithm are analyzed. Block 508 may be performed in a manner described above. In an example, the analyzing of the results may result in a particular facility being selected as the facility for the order. In an embodiment, the selection may be made based on what facility has been assigned the most instances of similar orders.

At block 510, a determination is made whether any outlier facilities exist from the clustering algorithm. Block 510 may be performed in a manner described above. In an example, an outlier facility may be any facility, other facility originally identified as the assigned facility for the order, that similar orders have recently been diverted to during manufacturing stage of information handling systems within an order. If no outlier facilities exist, the flow continues at block 514.

However, if outlier facilities exit, a configurator is run with outlier facilities at block 512. Block 512 may be performed in a manner described above. In an example, the configurator may include a set of rules to properly identify whether the originally assigned facility or a deviation should be assigned the order. In an embodiment, the rules may include whether an outlier facility is a second touch facility, whether multiple recent orders have been re-routed to a particular outlier facility, or the like.

At block 514, a manufacturing facility is derived. Block 514 may be performed in a manner described above. In an embodiment, based on the rules of the configurator, the manufacturing facility is derived from the originally assigned facility and the outlier facilities. The derived manufacturing facility is assigned the order.

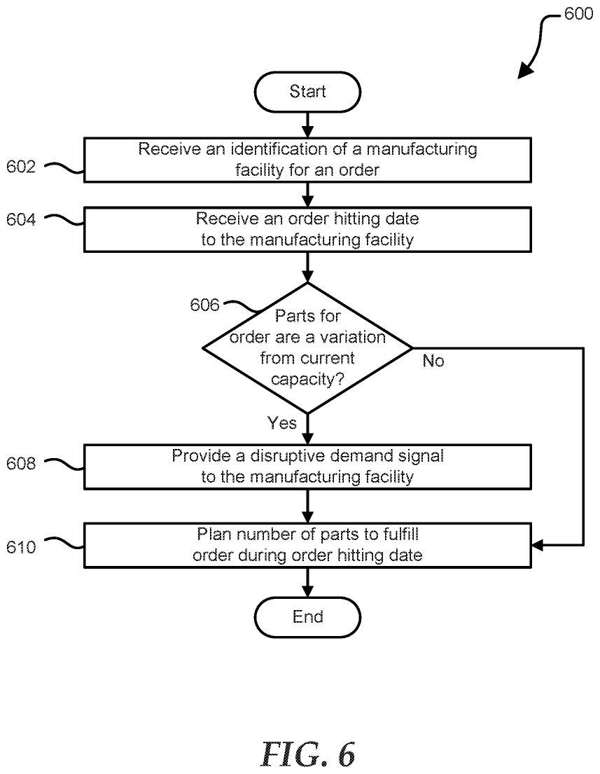

FIG. 6 is a flow diagram of a method for determining whether an order may be disruptive to an assigned facility according to at least one embodiment of the present disclosure. It will be readily appreciated that not every method step set forth in this flow diagram is always necessary, and that certain steps of the methods can be combined, performed simultaneously, in a different order, or perhaps omitted, without varying from the scope of the disclosure.

At block 602, an identification of a manufacturing facility for an order is received. Block 602 may be performed in a manner described above. In an example, the manufacturing facility for the order may be the facility derived in block 514 of FIG. 5.

At block 604, an order hitting date to the manufacturing facility is received. Block 604 may be performed in a manner described above. In an example, the order hitting date may be a time period, such as a particular week, that the order will be provided to the manufacturing facility so that the order will be fulfilled by the facility.

At block 606, a determination is made whether the parts required for the order result in a variation from current capacity of the identified manufacturing facility. Block 606 may be performed in a manner described above. In certain examples, a comparison may be made between a daily sales inventory of parts available in the facility at the order hitting date and the number of parts needed to fulfill the order. If the number of parts needed to fulfill the order exceeds the daily sales inventory, then a determination is made that the parts required for the order results in a variation from the current capacity of the facility. If the parts required for the order is not a variation from a current capacity of the identified manufacturing facility, the flow continues at block 610.

However, if the parts required for the order is a variation from a current capacity of the identified manufacturing facility, a disruptive demand signal is provided to the manufacturing facility at block 608. Block 608 may be performed in a manner described above. In an example, the disruptive demand signal may notify the facility of the details of the order including, but not limited to, the size of the order, the parts needed for the order, and the time period that the order should be completed.

At block 610, a number of parts to fulfill the order during the order hitting date are planned. Block 610 may be performed in a manner described above. In an example, the plan may include increasing the number of parts in the daily sale inventory to ensure that the facility will have the necessary daily sales inventory to fulfill the disruptive order on time.

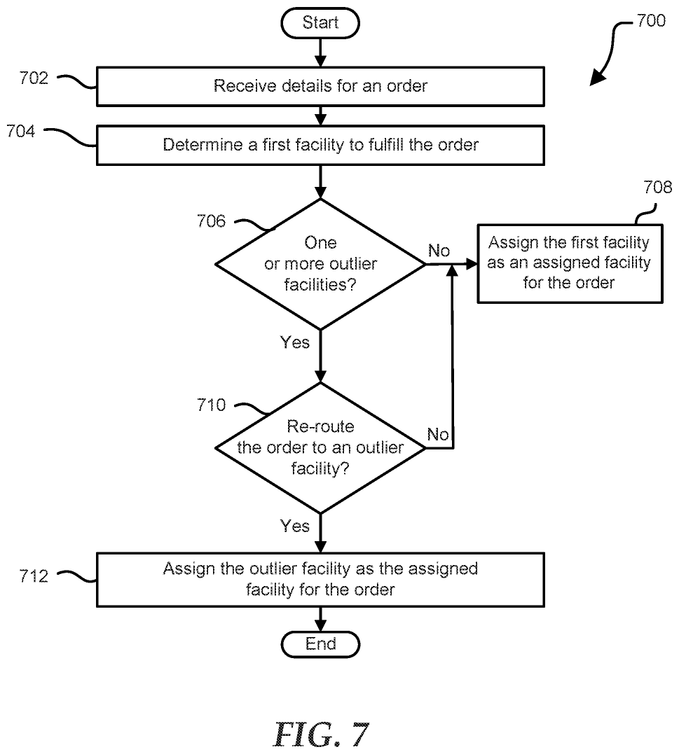

FIG. 7 is a flow diagram of a method 700 for deriving a manufacturing facility for an order according to at least one embodiment of the present disclosure. It will be readily appreciated that not every method step set forth in this flow diagram is always necessary, and that certain steps of the methods can be combined, performed simultaneously, in a different order, or perhaps omitted, without varying from the scope of the disclosure.

At block 702, details for an order are received. Block 702 may be performed in a manner described above. In an example, the details or parameters may include a type of order, such as desktop computer, server, or the like, the size of the order, a time period the order is to be completed, or the like. In an embodiment, the details may be utilized to generate a quote and confirmation of the order.

At block 704, a first facility to fulfill the order is determined. Block 704 may be performed in a manner described above. In an example, this determination may be made via the execution of a facility prediction model, and the determined facility may be the facility that has been assigned the most instances of similar orders.

At block 706, a determination is made whether one or more outlier facilities exist for the order. Block 706 may be performed in a manner described above. In an example, an outlier facility may be any facility, other facility originally identified as the assigned facility for the order, that similar orders have recently been diverted to during manufacturing stage of information handling systems within an order.

If no outliers exist, the first facility is assigned as an assigned facility for the order at block 708. Block 708 may be performed in a manner described above.

If one or more outliers exist, a determination is made whether the order is to be re-routed to an outlier facility at block 710. Block 710 may be performed in a manner described above. In an example, this determination is made based on whether the outlier facility is a second touch facility, whether multiple recent orders have been re-routed to the outlier facility, or the like. If the determination is made that the order is not to be re-routed, the flow continues as described above at block 708.

If the determination is made that the order is to be re-routed, the outlier facility is assigned as the assigned facility for the order at block 712. Block 712 may be performed in a manner described above.

FIG. 8 illustrates a general information handling system 800 including a processor 802, a memory 804, a northbridge/chipset 806, a PCI bus 808, a universal serial bus (USB) controller 810, a USB 812, a keyboard device controller 814, a mouse device controller 816, a configuration an ATA bus controller 820, an ATA bus 822, a hard drive device controller 824, a compact disk read only memory (CD ROM) device controller 826, a video graphics array (VGA) device controller 830, a network interface controller (NIC) 840, a wireless local area network (WLAN) controller 850, a serial peripheral interface (SPI) bus 860, a NVRAM 870 for storing BIOS 872, and a baseboard management controller (BMC) 880. In an embodiment, information handling system 800 may be information handling system 100 of FIG. 1 and/or information handling system 200 of FIG. 2. BMC 880 can be referred to as a service processor or embedded controller (EC). Capabilities and functions provided by BMC 880 can vary considerably based on the type of information handling system. For example, the term baseboard management system is often used to describe an embedded processor included at a server, while an embedded controller is more likely to be found in a consumer-level device. As disclosed herein, BMC 880 represents a processing device different from CPU 802, which provides various management functions for information handling system 800. For example, an embedded controller may be responsible for power management, cooling management, and the like. An embedded controller included at a data storage system can be referred to as a storage enclosure processor.

For purpose of this disclosure information handling system 800 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 800 can be a personal computer, a laptop computer, a smart phone, a tablet device or other consumer electronic device, a network server, a network storage device, a switch, a router, or another network communication device, or any other suitable device and may vary in size, shape, performance, functionality, and price. Further, information handling system 800 can include processing resources for executing machine-executable code, such as CPU 802, a programmable logic array (PLA), an embedded device such as a System-on-a-Chip (SoC), or other control logic hardware. Information handling system 800 can also include one or more computer-readable medium for storing machine-executable code, such as software or data.

System 800 can include additional processors that are configured to provide localized or specific control functions, such as a battery management controller. Bus 860 can include one or more busses, including a SPI bus, an I2C bus, a system management bus (SMBUS), a power management bus (PMBUS), and the like. BMC 880 can be configured to provide out-of-band access to devices at information handling system 800. As used herein, out-of-band access herein refers to operations performed prior to execution of BIOS 872 by processor 802 to initialize operation of system 800.

BIOS 872 can be referred to as a firmware image, and the term BIOS is herein used interchangeably with the term firmware image, or simply firmware. BIOS 872 includes instructions executable by CPU 802 to initialize and test the hardware components of system 800, and to load a boot loader or an operating system (OS) from a mass storage device. BIOS 872 additionally provides an abstraction layer for the hardware, such as a consistent way for application programs and operating systems to interact with the keyboard, display, and other input/output devices. When power is first applied to information handling system 800, the system begins a sequence of initialization procedures. During the initialization sequence, also referred to as a boot sequence, components of system 800 are configured and enabled for operation, and device drivers can be installed. Device drivers provide an interface through which other components of the system 800 can communicate with a corresponding device.

Information handling system 800 can include additional components and additional busses, not shown for clarity. For example, system 800 can include multiple processor cores, audio devices, and the like. While a particular arrangement of bus technologies and interconnections is illustrated for the purpose of example, one of skill will appreciate that the techniques disclosed herein are applicable to other system architectures. System 800 can include multiple CPUs and redundant bus controllers. One or more components can be integrated together. For example, portions of northbridge/chipset 806 can be integrated within CPU 802. Additional components of information handling system 800 can include one or more storage devices that can store machine-executable code, one or more communications ports for communicating with external devices, and various input and output (I/O) devices, such as a keyboard, a mouse, and a video display. An example of information handling system 800 includes a multi-tenant chassis system where groups of tenants (users) share a common chassis, and each of the tenants has a unique set of resources assigned to them. The resources can include blade servers of the chassis, input/output (I/O) modules, Peripheral Component Interconnect-Express (PCIe) cards, storage controllers, and the like.

Information handling system 800 can include a set of instructions that can be executed to cause the information handling system to perform any one or more of the methods or computer based functions disclosed herein. The information handling system 800 may operate as a standalone device or may be connected to other computer systems or peripheral devices, such as by a network.

In a networked deployment, the information handling system 800 may operate in the capacity of a server or as a client user computer in a server-client user network environment, or as a peer computer system in a peer-to-peer (or distributed) network environment. The information handling system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single information handling system 800 is illustrated, the term “system” shall also be taken to include any collection of systems or sub-systems that individually or jointly execute a set, or multiple sets, of instructions to perform one or more computer functions.

The information handling system 800 can include a disk drive unit and may include a computer-readable medium, not shown in FIG. 8, in which one or more sets of instructions, such as software, can be embedded. Further, the instructions may embody one or more of the methods or logic as described herein. In a particular embodiment, the instructions may reside completely, or at least partially, within system memory 804 or another memory included at system 800, and/or within the processor 802 during execution by the information handling system 800. The system memory 804 and the processor 802 also may include computer-readable media.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a processor or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method comprising:
determining, at a facility assignment system and based on details for an order and based on a facility prediction model, a first facility to fulfill the order, wherein the order includes multiple information handling systems;
determining, at the facility assignment system, whether one or more outlier facilities exist for the order;
based on the determination of whether the one or more outlier facilities exist, assigning, at the facility assignment system, the first facility as an assigned facility for the order; and
in response to a determination that one or more outlier facilities exist:
determining, at the facility assignment system and based on a set of routing rules, whether to re-route the order to a second one of the outlier facilities; and
assigning, at the facility assignment system and based on the re-routing determination, either the first facility or the second facility as the assigned facility for the order.

2. The method of claim 1, further comprising:
determining whether the order is disruptive to a capacity of the assigned facility; and
in response to the order being disruptive, sending a demand signal to the assigned facility, wherein the demand signal indicates materials needed at the assigned facility to complete the order.

3. The method of claim 2, wherein the determining of whether the order is disruptive to the capacity of the assigned facility comprises:
determining, based on capacity data associated with the assigned facility, whether the order satisfies a capacity threshold for the assigned facility during a week associated with an order completion date for the order; and
in response to the order satisfying the capacity threshold, determining that the order is disruptive to the capacity of the assigned facility.

4. The method of claim 3, wherein the capacity data includes a sales order history for the week associated with the order completion date, a daily sales inventory maintained at the assigned facility during the week associated with the order completion date, a capacity planning for the assigned facility during the week associated with the order completion date, and holidays associated with the assigned facility.

5. The method of claim 1, wherein the determining of whether to re-route the order to the second facility comprises:
determining whether the second facility is a second touch facility for a type of information handling system of the order;
in response to the second facility being the second touch facility, eliminating the second facility as a possibility for re-routing the order; and
in response to the second facility not being the second touch facility:
determining whether a threshold number of last orders similar to the order were re-routed to the second facility; and
in response to the threshold number of last orders being re-routed to the second facility, re-routing the order to the second facility.

6. The method of claim 1, wherein the set of routing rules includes latest routing of similar orders, historical re-routing of orders for the first facility, shipping patterns, and whether a product of the order is a new product.

7. The method of claim 1, wherein the details for the order include an order completion date, a type of information handling system for the order, and a quantity of the type of information handling system.

8. An information handling system comprising:
a memory to store a set of instructions; and
a processor to execute the set of instructions, the set of instructions when executed cause the processor to:
receive details for an order, wherein the order includes multiple information handling systems;
determine, based on the details for the order and based on a facility prediction model, a first facility to fulfill the order;
determine whether one or more outlier facilities exist for the order;
in response to a determination that no outlier facilities exist, assign the first facility as an assigned facility for the order; and
in response to a determination that one or more outlier facilities exist:
determine, based on a set of routing rules, whether to re-route the order to a second one of the outlier facilities; and
assign, based on the re-routing determination, either the first facility or the second facility as the assigned facility for the order.

9. The information handling system of claim 8, the processor further to determine whether the order is disruptive to a capacity of the assigned facility, and in response to the order being disruptive, send a demand signal to the assigned facility, wherein the demand signal indicates materials needed at the assigned facility to complete the order.

10. The information handling system of claim 9, wherein the determination of whether the order is disruptive to the capacity of the assigned facility comprises:
the processor to:
determine, based on capacity data associated with the assigned facility, whether the order satisfies a capacity threshold for the assigned facility during a week associated with an order completion date for the order; and
in response to the order satisfying the capacity threshold, determine that the order is disruptive to the capacity of the assigned facility.

11. The information handling system of claim 10, wherein the capacity data includes a sales order history for the week associated with the order completion date, a daily sales inventory maintained at the assigned facility during the week associated with the order completion date, a capacity planning for the assigned facility during the week associated with the order completion date, and holidays associated with the assigned facility.

12. The information handling system of claim 11, wherein the determination of whether to re-route the order to the second facility comprises:
the processor to:
determine whether the second facility is a second touch facility for a type of information handling system of the order;
in response to the second facility being the second touch facility, eliminate the second facility as a possibility for re-routing the order; and
in response to the second facility not being the second touch facility:
determine whether a threshold number of last orders similar to the order were re-routed to the second facility; and
in response to the threshold number of last orders being re-routed to the second facility, re-route the order to the second facility.

13. The information handling system of claim 8, wherein the set of routing rules includes latest routing of similar orders, historical re-routing of orders for the first facility, shipping patterns, and whether a product of the order is a new product.

14. The information handling system of claim 8, wherein the details for the order include an order completion date, a type of information handling system for the order, and a quantity of the type of information handling system.

15. A method comprising:
receiving, at a quote system, details for an order, wherein the order includes multiple information handling systems;
defining, by the quote system, a confirmation of the order based on details of the order;
determining, at a facility assignment system and based on the details for the order and based on a facility prediction model, a first facility to fulfill the order;
determining, at the facility assignment system, whether one or more outlier facilities exist for the order;
in response to a determination that no outlier facilities exist, assigning the first facility as an assigned facility for the order;
in response to a determination that one or more outlier facilities exist:
determining, at the facility assignment system and based on a set of routing rules, whether to re-route the order to a second facility of the one or more outlier facilities; and
assigning, at the facility assignment system and based on the re-routing determination, either the first facility or the second facility as the assigned facility for the order;
determining whether the order is disruptive to a capacity of the assigned facility; and
in response to the order being disruptive, sending a demand signal to the assigned facility, wherein the demand signal indicates materials needed at the assigned facility to complete the order.

16. The method of claim 15, wherein the determining of whether the order is disruptive to the capacity of the assigned facility comprises:
determining, based on capacity data associated with the assigned facility, whether the order satisfies a capacity threshold for the assigned facility during a week associated with an order completion date for the order; and
in response to the order satisfying the capacity threshold, determining that the order is disruptive to the capacity of the assigned facility.

17. The method of claim 16, wherein the capacity data includes a sales order history for the week associated with the order completion date, a daily sales inventory maintained at the assigned facility during the week associated with the order completion date, a capacity planning for the assigned facility during the week associated with the order completion date, and holidays associated with the assigned facility.

18. The method of claim 15, wherein the determining of whether to re-route the order to the second facility comprises:
determining whether the second facility is a second touch facility for a type of information handling system of the order;
in response to the second facility being the second touch facility, eliminating the second facility as a possibility for re-routing the order; and
in response to the second facility not being the second touch facility:
determining whether a threshold number of last orders similar to the order were re-routed to the second facility; and
in response to the threshold number of last orders being re-routed to the second facility, re-routing the order to the second facility.

19. The method of claim 15, wherein the details for the order include an order completion date, a type of information handling system for the order, and a quantity of the type of information handling system.

20. The method of claim 15, wherein the details for the order include an order completion date, a type of information handling system for the order, and a quantity of the type of information handling system.
